(19) United States
(12) Patent Application Publication
(10) Pub. No.: US 2020/0327589 A1
(43) Pub. Date: Oct. 15, 2020

(54) AUTHORIZING A TRANSACTION FOR A RESTRICTED ITEM BASED ON USER DATA

(71) Applicant: Capital One Services, LLC, McLean, VA (US)

(72) Inventors: Jessica GREENBERG, New York, NY (US); Taurean BUTLER, New York, NY (US); Adam VUKICH, Alexandria, VA (US)

(21) Appl. No.: 16/384,180

(22) Filed: Apr. 15, 2019

(51) Int. Cl. G06Q 30/06; G06Q 20/40; G06N 20/00; G06Q 20/34

(52) U.S. Cl. CPC G06Q 30/0607; G06Q 20/355; G06N 20/00; G06Q 20/4014

(57) ABSTRACT

A device may receive, from a transaction device, transaction data relating to a transaction event involving a transaction card that stores user data associated with a user. The transaction data may include the user data and a category identifier of a merchant associated with the transaction device. The device may process the category identifier to determine whether the merchant is associated with an item that has a purchase restriction. The device may determine whether the user data of the transaction data satisfies the purchase restriction. The device may transmit a notification to a user device associated with the user requesting that the user indicate whether the transaction event is approved by the user. The device may receive a response to the notification and selectively process the transaction event or reject the transaction event based on the response.

### BACKGROUND

Transactions often involve use of a transaction card (e.g., a credit card, a debit card, a gift card, an automated teller machine (ATM) card, a rewards card, a client loyalty card, and/or the like) to pay for products or services at a transaction terminal (e.g., point of sale (PoS) terminal), e.g., via a swiping of the transaction card at a card reader, insertion of the transaction card into a chip reader, or wireless transmission of transaction card data to a wireless receiver. In some instances, a magnetic strip, integrated circuit (IC) chip, radio frequency (RF) antenna, and/or radio frequency identification (RFID) tag may be included in a transaction card to provide information associated with the transaction card (e.g., an account identifier, account information, a payment token, and/or the like).

### SUMMARY

According to some implementations, a method may include receiving, by a device and from a transaction device, transaction data relating to a transaction event involving a transaction card, wherein the transaction device is associated with a merchant, wherein the transaction card stores user data associated with a user of the transaction card, and wherein the transaction data includes the user data and a category identifier of the merchant. The method may include processing, by the device, the category identifier to determine whether the merchant is associated with an item that has a purchase restriction. The method may include determining, by the device and based on determining that the merchant is associated with the item, whether the user data of the transaction data satisfies the purchase restriction. The method may include transmitting, by the device and based on determining that the user data satisfies the purchase restriction, a notification to a user device associated with the user, wherein the notification requests that the user indicate whether the transaction event is approved by the user. The method may include receiving, by the device and from the user device, a response to the notification and selectively processing the transaction event or rejecting the transaction event, by the device, based on the response.

According to some implementations, a non-transitory computer-readable medium may store instructions that include one or more instructions that, when executed by one or more processors of a device, may cause the one or more processors to receive, from a transaction device, transaction data relating to a transaction event involving a transaction card, wherein the transaction device is associated with a merchant, wherein the transaction card stores user data associated with a user of the transaction card, and wherein the transaction data includes the user data and a category identifier of the merchant. The one or more instructions may cause the one or more processors to process the category identifier to determine whether the merchant is associated with an item that has a purchase restriction. The one or more instructions may cause the one or more processors to determine, based on determining that the merchant is associated with the item, whether the user data satisfies the purchase restriction. The one or more instructions may cause the one or more processors to transmit, based on determining that the user data does not satisfy the purchase restriction, a notification to the transaction device, wherein the notification requests that the merchant identify whether the purchase restriction is applicable to the transaction event. The one or more instructions may cause the one or more processors to receive, from the transaction device, a response to the notification and selectively process the transaction event or reject the transaction event based on the response.

According to some implementations, a device may include one or more memories, and one or more processors, communicatively coupled to the one or more memories, to receive, from a transaction device, transaction data relating to a transaction event involving a transaction card, wherein the transaction device is associated with a merchant, wherein the transaction card stores user data associated with a user of the transaction card, and wherein the transaction data includes the user data and a category identifier of the merchant. The one or more processors may process the category identifier to determine whether the merchant is associated with an item that has a purchase restriction. The one or more processors may determine, based on determining that the merchant is associated with the item, whether the user data of the transaction data satisfies the purchase restriction. The one or more processors may selectively transmit, based on whether the user data satisfies the purchase restriction: a first notification to a user device associated with the user requesting that the user indicate whether the transaction event is approved by the user, or a second notification to the transaction device requesting that the merchant identify whether the purchase restriction is applicable to the transaction event. The one or more processors may receive a response to the first notification or the second notification and selectively process the transaction event or reject the transaction event based on the response.

### BRIEF DESCRIPTION OF THE DRAWINGS

FIGS. 1A-1C are diagrams of one or more example implementations described herein.

FIG. 2 is a diagram of an example environment in which systems and/or methods described herein may be implemented.

FIG. 3 is a diagram of example components of one or more devices of FIG. 2.

FIGS. 4-6 are flow charts of example processes for authorizing a transaction for a restricted item based on user data.

### DETAILED DESCRIPTION

The following detailed description of example implementations refers to the accompanying drawings. The same reference numbers in different drawings may identify the same or similar elements.

Transaction cards may be used to execute transactions at transaction terminals (e.g., PoS terminals). In some cases, a transaction may be a purchase transaction for an item (as used herein, “item” may refer to a good or a service) that has a purchase restriction. For example, with regard to a purchase transaction between a merchant and an individual for an alcoholic beverage, a purchase restriction may prescribe that the individual is to be at least a particular age (e.g., at least 21 years of age in the United States) to participate in the purchase transaction. As another example, with regard to a purchase transaction between a merchant and an individual for fireworks, a purchase restriction may prescribe that the individual is not to be a resident of a particular jurisdiction to participate in the purchase transaction (e.g., not a resident of a jurisdiction where the merchant is located).

According to current techniques, a merchant may request that the individual present a form of identification (e.g., a government-issued identification) that contains information relating to an age, an address, a status, and/or the like of the individual before allowing the individual to participate in a purchase transaction involving a purchase restriction. Sometimes, a merchant may attempt to reduce legal exposure relating to unauthorized transactions by maintaining a record of a form of identification presented by an individual in a purchase transaction for an item having a purchase restriction. For example, the merchant may capture and store a digital copy of the form of identification, may extract and store information contained on the form of identification (e.g., by optical character recognition), may manually enter and store information contained on the form of identification, and/or the like. However, this practice may require use of a third-party device or system that may lack widespread interoperability with transaction devices (e.g., PoS terminals). In some cases, the merchant may implement a policy to check, and/or maintain a record of, a form of identification for an individual in any transaction involving a purchase restriction (e.g., the policy may require the merchant to check, and/or maintain a record of, a form of identification for an alcoholic beverage transaction involving an individual that is 90 years of age). As a result, the merchant may consume considerable computing resources (e.g., processing resources, memory resources, and/or the like) associated with maintaining records for hundreds, thousands, millions, or more transactions.

In a related issue, sometimes, the form of identification possessed by the individual may be forged or may belong to another individual. Accordingly, current techniques are susceptible to permitting an unauthorized transaction (e.g., a minor using a stolen transaction card or a parent's transaction card without permission) for an item having a purchase restriction. Unauthorized transactions may cause millions or billions of dollars in additional expenses for a financial institution that issued a transaction card involved in the unauthorized transaction as well as waste computing and network resources involved in identifying, investigating, and/or correcting fraudulent or illegal activity.

Some implementations described herein may utilize user data that is stored on a transaction card to determine whether a purchase restriction associated with a transaction is satisfied. For example, a transaction authorization platform may obtain transaction data relating to a transaction involving a transaction card that stores user data. The transaction data may include the user data and a category identifier of a merchant associated with the transaction. The transaction authorization platform may process the category identifier to determine whether the merchant is associated with an item having a purchase restriction. When the user data satisfies the purchase restriction, the transaction authorization platform may transmit a notification to a user device associated with the transaction card requesting approval of the transaction and selectively process or reject the transaction based on a response to the notification. When the user data does not satisfy the purchase restriction, the transaction authorization platform may transmit a notification to a transaction device (e.g., PoS terminal) associated with the merchant requesting that the merchant identify whether a purchase restriction is applicable to the transaction and selectively process or reject the transaction based on a response to the notification.

In this way, the transaction authorization platform may determine whether a user associated with the transaction card satisfies a purchase restriction, thereby discharging the merchant from checking a form of identification. Accordingly, unauthorized transactions made possible by human error and/or fraudulent identification may be reduced or eliminated, thereby conserving computing and network resources involved in identifying, investigating, and/or correcting fraudulent or illegal activity.

In addition, the transaction authorization platform may process a transaction when approval of the transaction is provided, thereby ensuring that transactions involving a purchase restriction receive authorization. Moreover, the approval of the transaction, alone or combined with the user data, provides information that may be stored in a record supporting that a purchase restriction associated with the transaction was satisfied. In this way, records that may otherwise be collected and maintained by the merchant (e.g., digital copies of a form of identification, information extracted from a form of identification, etc.) may be eliminated, thereby conserving computing and storage resources associated with maintaining the records.

Furthermore, the transaction authorization platform may combine tasks relating to purchase restriction verification and transaction processing into an integrated system. In this way, the transaction authorization platform may reduce inefficiencies that may result from a lack of interoperability between a transaction device (e.g., PoS terminals) and a third-party device or system (e.g., a third-party device or system used to capture a digital copy of a form of identification, extract information from a form of identification, store information relating to a form of identification, etc.).

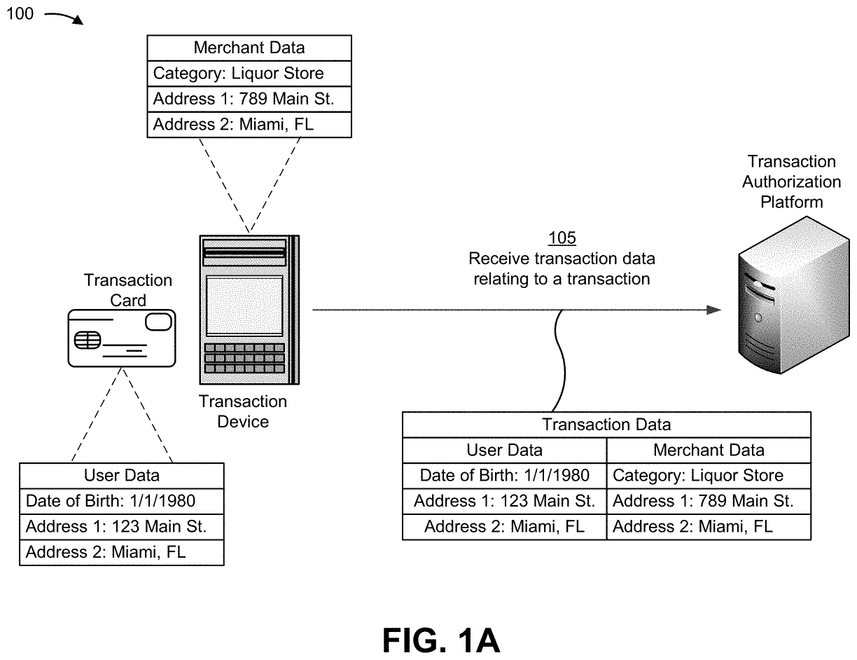

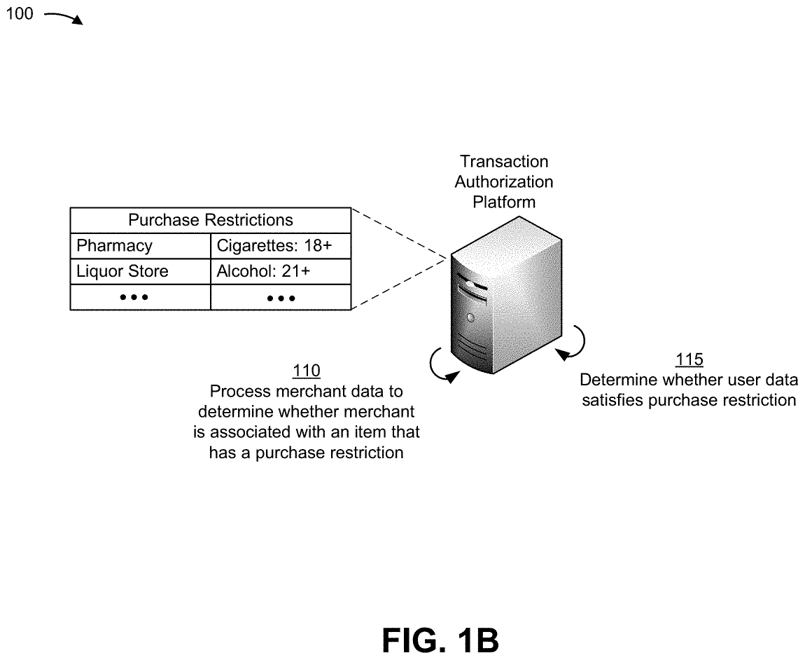

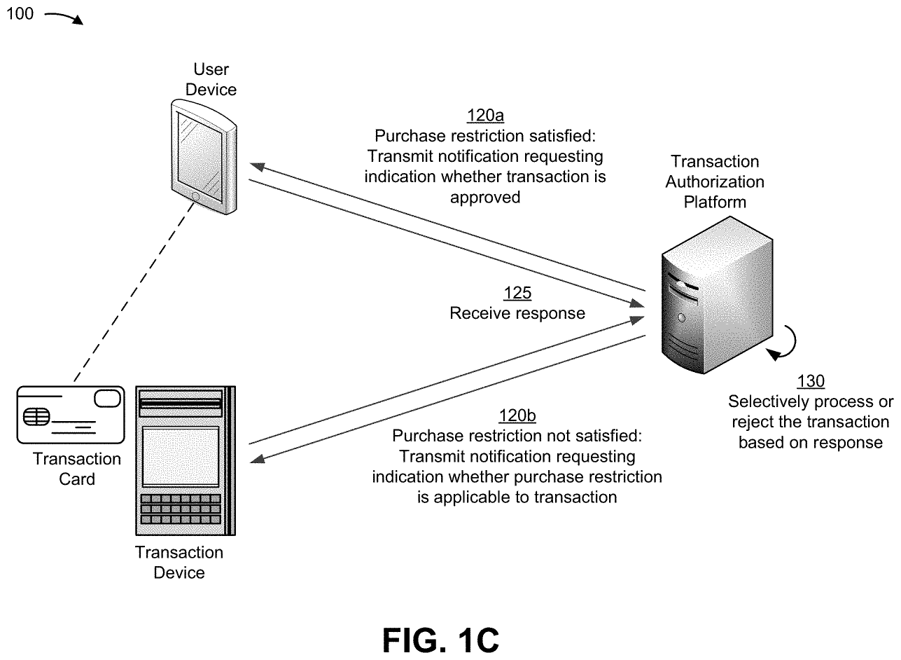

FIGS. 1A-1C are diagrams of one or more example implementations 100 described herein. As shown in FIGS. 1A-1C, example implementation(s) 100 may include a transaction card, a user device, a transaction device, and a transaction authorization platform.

The transaction card (e.g., a credit card, a debit card, a bank card, and/or the like) may be used in connection with the transaction device to perform a transaction to purchase goods and/or services. The transaction card may store payment data relating to an account associated with the transaction card (e.g., an account number, an expiration date, etc.) and/or user data relating to a user of the transaction card (e.g., an owner of the transaction card). For example, the transaction card may store user data relating to a date of birth of the user, an address of the user, a residency of the user, a citizenship of the user, a status of the user (e.g., whether the user has been convicted of a felony, whether the user has achieved a particular status with regard to the transaction card or a merchant (e.g., a rewards member, a platinum member, etc.)), and/or the like. The payment data and/or user data may be provided to the transaction device as part of a transaction (e.g., by inserting the transaction card into a chip reader of the transaction device, by swiping the transaction card through a magnetic strip reader of the transaction device, by wireless transmission from the transaction card to a wireless receiver of the transaction device (e.g., a tap-to-pay system), and/or the like).

The user device (e.g., a smart phone, an internet of things (IoT) device, a wearable communications device, and/or the like) may be associated with a user of the transaction card (e.g., an owner of the transaction card, an authorized user of the transaction card, and/or the like). In some implementations, a user of the transaction card and a user of the user device, with respect to a particular transaction, may be a same individual or different individuals.

The transaction device (e.g., a PoS terminal) may be an electronic telecommunications device that enables a user to perform a transaction. The transaction device may communicate transaction data relating to a transaction to the transaction authorization platform. The transaction device may be associated with a merchant involved in selling goods and/or services. The transaction device may be associated with a physical location of the merchant (e.g., a brick-and-mortar location) or a digital location of the merchant (e.g., an Internet website). In some implementations, the transaction device may store, or have access to another device that stores, merchant data, such as a category identifier of the merchant (e.g., information identifying a merchant category code of the merchant (e.g., grocery store, pharmacy, etc.), a service category of the merchant (e.g., restaurant service, entertainment service, etc.), a product category of the merchant (e.g., food, electronics, gasoline, etc.), and/or the like), an address of the merchant, and/or the like. In some implementations, the transaction device may store, or have access to another device that stores, item data relating to goods and/or services offered by the merchant (e.g., an item identifier, an item stock keeping unit (SKU), an item category (e.g., an item commodity code), an item description, and/or the like).

The transaction authorization platform may be a computing device, a server, a cloud computing device, and/or the like that monitors and/or authorizes one or more transactions of the transaction device. The transaction authorization platform may be associated with a financial institution (e.g., a financial institution that issued a transaction card). In some implementations, the transaction authorization platform may receive transaction data from the transaction device as part of a transaction authorization request. The transaction authorization platform may determine whether to process the transaction authorization request or reject the transaction authorization request based on the transaction data. For example, the transaction authorization platform may determine to reject the transaction authorization request when the transaction data indicates a potential unauthorized transaction.

Some example implementations described herein concern a single transaction device, transaction authorization platform, transaction card, user device, and/or user, but implementations may include a plurality of transaction devices, transaction authorization platforms, transaction cards, user devices, and/or users. In some implementations, the transaction device, the transaction authorization platform, and/or the user device may be connected via a network, such as the internet, an intranet, and/or the like.

As shown in FIG. 1A, and by reference number 105, the transaction authorization platform may receive transaction data relating to a transaction event involving a transaction card. For example, the transaction authorization platform may receive the transaction data from a transaction device associated with a merchant. The merchant may offer for sale one or more items associated with a purchase restriction.

In some implementations, the transaction data may include user data relating to a user of the transaction card (e.g., an owner of the transaction card). For example, the transaction data may include user data relating to a date of birth of the user, an address of the user, a residency of the user, a citizenship of the user, a status of the user, and/or the like. In some implementations, the transaction data may include merchant data relating to the merchant associated with the transaction device. For example, the merchant data may include merchant data relating to a category identifier of the merchant, an address of the merchant, and/or the like. In some implementations, the transaction data may include item data relating to an item involved in the transaction event, such as an item identifier of the item.

In some implementations, the transaction event may be a transaction preauthorization request. For example, the transaction preauthorization request may be associated with a tab (e.g., a bar tab) opened with the merchant. Additionally, or alternatively, the transaction event may be a transaction authorization request. For example, the transaction authorization request may be associated with a purchase transaction (e.g., a checkout transaction) for a good and/or a service.

As shown in FIG. 1B, and by reference number 110, the transaction authorization platform may process the merchant data included in the transaction data to determine whether the merchant is associated with an item that has a purchase restriction. In some implementations, the transaction authorization platform may determine whether the merchant is associated with an item having a purchase restriction based on a category identifier of the merchant (e.g., a merchant category code) included in the transaction data. In some implementations, the transaction authorization platform may determine whether the merchant is associated with an item having a purchase restriction based on an item identifier associated with the transaction event (e.g., an item commodity code) included in the transaction data. In some implementations, the transaction authorization platform may determine whether the merchant is associated with an item having a purchase restriction based on the category identifier and the item identifier.

In some implementations, the transaction authorization platform may utilize a mapping of category identifiers and/or item identifiers to purchase restrictions in order to determine whether the merchant is associated with an item having a purchase restriction. For example, the mapping may associate a category identifier for grocery stores with a purchase restriction relating to alcoholic beverages, a category identifier for liquor stores with a purchase restriction relating to alcoholic beverages, a category identifier for sporting goods stores with a purchase restriction relating to firearms, a category identifier for movie theaters with a purchase restriction relating to R-rated movies, etc. As another example, the mapping may associate an item identifier for alcoholic beverages to a purchase restriction relating to alcoholic beverages, an item identifier for fireworks to a purchase restriction relating to fireworks, an item identifier for firearms to a purchase restriction relating to firearms, etc. The mapping may be stored in a data structure (e.g., a data repository, a database, a table, a list, and/or the like) that is accessible to the transaction authorization platform.

In some implementations, the transaction authorization platform may utilize a model, such as a machine-learning model, to determine whether the merchant is associated with an item having a purchase restriction. For example, a machine-learning model may output an indication whether the merchant is associated with an item having a purchase restriction based on the category identifier and/or the item identifier.

In some implementations, an item identifier and/or a category identifier may identify a purchase restriction. For example, a category identifier may be a merchant category code that identifies a merchant as being associated with an item having a purchase restriction. As another example, an item identifier may be an item commodity code that identifies an item as being associated with a purchase restriction.

In some implementations, the transaction authorization platform (e.g., using a mapping or a machine-learning model) may identify a scope of a purchase restriction associated with the merchant (e.g., based on a merchant identifier or an item identifier). For example, the transaction authorization platform may identify that a purchase restriction associated with alcoholic beverages or R-rated movies relates to a minimum age (e.g., 21 years of age or 17 years of age), a purchase restriction associated with firearms relates to a status (e.g., a non-felon status), a purchase restriction associated with fireworks relates to a residency (e.g., a residency outside of a particular jurisdiction), and/or the like. In some implementations, the transaction authorization platform may identify that a purchase restriction relates to a membership status of a user of the transaction card (e.g., the purchase restriction may require that the user is to be in a membership club of a merchant, require that the user is to have achieved a particular status in connection with a transaction card (e.g., a platinum status, a diamond status, etc.), and/or the like).

In some implementations, the transaction authorization platform (e.g., using a mapping or a machine-learning model) may identify a scope of the purchase restriction that is applicable to a particular merchant based on the merchant data. For example, the transaction authorization platform may identify the scope of the purchase restriction based on an address of the merchant. For example, for a purchase restriction relating to alcoholic beverages, the transaction authorization platform may determine that a minimum age of 21 years is applicable to a merchant, based on an address of the merchant (e.g., an address in the United States). Thus, the transaction authorization platform may identify a scope of a purchase restriction that is different for merchants associated with identical or similar category identifiers and/or item identifiers. For example, the transaction authorization platform may determine that a minimum age to purchase cigarettes applicable to a first merchant having a first address (e.g., in a first jurisdiction) is different from a minimum age to purchase cigarettes applicable to a second merchant having a second address (e.g., in a second jurisdiction).

As shown by reference number 115, the transaction authorization platform may determine whether user data (e.g., user data provided by the transaction card) included in the transaction data satisfies a purchase restriction. In some implementations, after identifying a purchase restriction that may be applicable to the transaction event, the transaction authorization platform may compare the user data to the purchase restriction to determine whether the user data satisfies the purchase restriction. For example, if the purchase restriction relates to a minimum age (e.g., to purchase an alcoholic beverage), the transaction authorization platform may compare an age associated with a date of birth of the user data to the minimum age of the purchase restriction. As another example, if the purchase restriction relates to a particular residency, the transaction authorization platform may compare a residency of the user data to the particular residency of the purchase restriction.

In some implementations, the transaction authorization platform may process the transaction event based on determining that the user data satisfies the purchase restriction (e.g., without transmitting a notification, as described below). In some implementations, the transaction authorization platform may reject the transaction event based on determining that the user data does not satisfy the purchase restriction (e.g., without transmitting a notification, as described below). For example, based on transaction data that contains an item identifier of an item associated with a purchase restriction, the transaction authorization platform may reject the transaction event based on determining that the user data does not satisfy the purchase restriction.

As shown in FIG. 1C, and by reference number 120a, the transaction authorization platform may transmit a notification to a user device associated with a user of the transaction card (e.g., an owner of the transaction card). For example, the transaction authorization platform may transmit a notification to the user device based on determining that the purchase restriction is satisfied. In some implementations, the user may be a party to the transaction event (e.g., the user is attempting to make a purchase with the merchant). Additionally, or alternatively, the user may not be associated with the transaction event (e.g., an individual in possession of a transaction card of the user is attempting to make a purchase with the merchant). In some implementations, the transaction authorization platform may transmit the notification to the user device by a text message (e.g., a short message service message), an email, a push notification (e.g., associated with an application of the user device), a telephone call, and/or the like.

In some implementations, the notification may request that the user identify whether the transaction event is approved by the user. In this way, the transaction authorization platform may prevent an ineligible user (e.g., a user that does not satisfy a purchase restriction) from obtaining an item having a purchase restriction unless the transaction event is approved by the user. Accordingly, an unauthorized transaction that may otherwise be processed by the transaction authorization platform (e.g., because user data satisfies a purchase restriction) may be detected by the transaction authorization platform.

In some implementations, the transaction authorization platform may transmit a notification to the user device requesting that the user provide information to verify that the user satisfies the purchase restriction. Such a notification may be useful when the transaction authorization platform has determined that the user data does not satisfy the purchase restriction. In some implementations, the notification may request that the user provide an image (e.g., captured by the user device) of a form of identification of the user (e.g., if the user data does not satisfy a purchase restriction relating to alcoholic beverages). Additionally, or alternatively, the notification may request that the user present a form of identification to the merchant and receive, from the merchant, information (e.g., a verification code) that provides verification that the user satisfies the purchase restriction.

In some implementations, the transaction authorization platform may transmit a notification to the transaction device when transmitting the notification to the user device. For example, the transaction authorization platform may transmit a notification to the transaction device indicating that the transaction authorization platform is awaiting a response to the notification transmitted to the user device.

As shown by reference number 120b the transaction authorization platform may transmit a notification to the transaction device of the merchant. For example, the transaction authorization platform may transmit a notification to the transaction device based on determining that the purchase restriction is not satisfied. The notification may request that the merchant identify whether the purchase restriction is applicable to the transaction event. In this way, the transaction authorization platform may prevent an ineligible user (e.g., a user that does not satisfy a purchase restriction) from obtaining an item having a purchase restriction without the merchant checking, and/or maintaining a record of, a form of identification of an individual involved in the transaction event.

In some implementations, the transaction authorization platform may transmit a notification to the transaction device requesting that the merchant provide information to verify that the user satisfies the purchase restriction. Such a notification may be useful when the transaction authorization platform has determined that the user data satisfies the purchase restriction (e.g., to provide an additional layer of verification of the purchase restriction). For example, the notification may request that the merchant examine a form of identification of the user and enter information contained by the form of identification to the transaction device (e.g., a date of birth). As another example, the notification may request that the merchant provide information relating to the purchase restriction (e.g., provide information relating to a minimum age for purchasing cigarettes in a jurisdiction where the merchant is located).

In some implementations, the transaction authorization platform may transmit the notification to the transaction device using a transaction response code (e.g., an alphanumeric identifier). For example, after receiving a transaction authorization request from the merchant, the transaction authorization platform may respond to the transaction authorization request with a transaction response code that is associated with a particular message or request. In some implementations, the transaction device may identify the particular message or request associated with the transaction response code and display the particular message or request on a display of the transaction device.

In some implementations, the transaction authorization platform may transmit one or more of the notifications described above to the user device and/or one or more of the notifications described above to the transaction device. In some implementations, one or more of the notifications indicated as being transmitted to the user device may be transmitted to the transaction device, and/or one or more of the notifications indicated as being transmitted to the transaction device may be transmitted to the user device.

As shown by reference number 125, the transaction authorization platform may receive a response to a notification. In some implementations, the transaction authorization platform may receive, from a user device, a response to a notification transmitted to the user device. For example, the transaction authorization platform may receive a response from the user device indicating that the transaction event is approved or that the transaction event is not approved. In some implementations, the transaction authorization platform may receive, from a transaction device, a response to a notification transmitted to the transaction device. For example, the transaction authorization platform may receive a response from the transaction device indicating that a purchase restriction is applicable to the transaction event or that a purchase restriction is not applicable to the transaction event.

In some implementations, a response from the user device may include an image of a form of identification of a user or a verification code provided by the merchant (e.g., in response to a notification from the transaction authorization platform requesting that the user provide information to verify that the user satisfies the purchase restriction). In some implementations, a response from the transaction device may include information from a form of identification of a user or information relating to a purchase restriction (e.g., in response to a notification from the transaction authorization platform requesting that the transaction device provide information to verify that the user satisfies the purchase restriction).

In some implementations, the transaction authorization platform may reject the transaction event if a response to the notification is not received within a time period after the notification is transmitted (e.g., 5 seconds, 30 seconds, 1 minute, etc.). For example, the transaction authorization platform may reject the transaction event if a response from a user device (e.g., indicating whether the transaction event is approved) is not received within ten seconds after the notification is transmitted.

As shown by reference number 130, the transaction authorization platform may selectively process the transaction event or reject the transaction event based on a response from the user device and/or the transaction device. In this way, the transaction authorization platform may reduce unauthorized transactions (e.g., transactions that violate a purchase restriction) to thereby conserve computing and network resources involved in identifying, investigating, and/or correcting fraudulent or illegal activity.

In some implementations, the transaction authorization platform may process the transaction event based on a response from a user device indicating that the transaction event is approved. Alternatively, the transaction authorization platform may reject the transaction event based on a response from a user device indicating that the transaction event is not approved. In some implementations, after receiving a response from the user device indicating that the transaction event is not approved, the transaction authorization platform may transmit a notification to the transaction device indicating that the transaction event is rejected because the transaction event is not approved.

In some implementations, the transaction authorization platform may process the transaction event based on a response from a transaction device indicating that a purchase restriction is not applicable to the transaction event. For example, after determining that user data associated with a transaction event does not satisfy a purchase restriction associated with a liquor store (e.g., a minimum age to purchase alcoholic beverages), the transaction authorization platform may process the transaction event associated with the liquor store based on a response from the transaction device indicating that the purchase restriction is not applicable to the transaction event (e.g., the transaction event relates to a purchase of non-alcoholic beverages).

In some implementations, the transaction authorization platform may reject the transaction event based on a response from a transaction device indicating that a purchase restriction is applicable to the transaction event. For example, after determining that user data does not satisfy the purchase restriction associated with the merchant, the transaction authorization platform may reject the transaction event based on a response from the transaction device indicating that the purchase restriction is applicable to the transaction event. In some implementations, after receiving a response from the transaction device indicating that the purchase restriction is applicable to the transaction event, the transaction authorization platform may transmit a notification to the transaction device indicating that the transaction event is rejected because the user data does not satisfy the purchase restriction.

In some implementations, the transaction authorization platform may determine whether to process or reject the transaction event based on a response from a user device that includes information to verify that a user satisfies a purchase restriction (e.g., an image of a form of identification, a verification code provided by a merchant, and/or the like). For example, the transaction authorization platform may process an image of a form of identification (e.g., utilizing a machine-learning model) to identify data relevant to a purchase restriction, determine whether the data satisfies the purchase restriction, and process or reject the transaction based on whether the data satisfies the purchase restriction. As another example, the transaction authorization platform may process a verification code to authenticate the verification code, and process or reject the transaction based on whether the verification code is authenticated.

In some implementations, the transaction authorization platform may determine whether to process or reject the transaction event based on a response from a merchant that includes information to verify that a user satisfies a purchase restriction (e.g., information contained by a form of identification, information relating to a purchase restriction, and/or the like). For example, the transaction authorization platform may determine whether information contained by a form of identification satisfies the purchase restriction, and process or reject the transaction based on whether the information satisfies the purchase restriction. As another example, the transaction authorization platform may determine a purchase restriction (e.g., a scope of a purchase restriction) based on the information relating to the purchase restriction, compare user data to the purchase restriction, and process or reject the transaction based on whether the user data satisfies the purchase restriction.

In some implementations, when processing or rejecting the transaction event, the transaction authorization platform may generate a record that associates information identifying the transaction event (e.g., a merchant identifier of the transaction event, a user identifier of the transaction event, a transaction card identifier of the transaction event, an amount of the transaction event, and/or the like), information identifying a purchase restriction associated with the transaction event (e.g., a purchase restriction associated with alcoholic beverages), information identifying a response to a notification (e.g., an indicator of whether the response indicated an approval of the transaction event, an indicator of whether the response indicated that a purchase restriction is applicable to the transaction event, and/or the like), and/or information identifying whether the transaction event was processed or rejected by the transaction authorization platform. In this way, a record relating to the transaction may be maintained by the transaction authorization platform to thereby permit efficient investigation and resolution of a claim that the transaction event was unauthorized.

As indicated above, FIGS. 1A-1C are provided as one or more examples. Other examples may differ from what is described with regard to FIGS. 1A-1C.

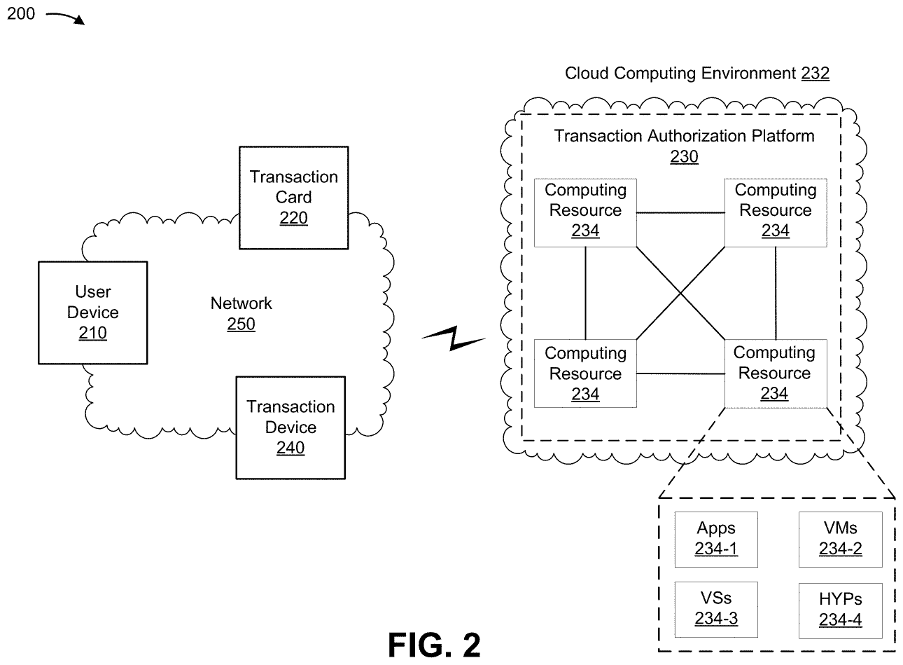

FIG. 2 is a diagram of an example environment 200 in which systems and/or methods described herein may be implemented. As shown in FIG. 2, environment 200 may include a user device 210, a transaction card 220, a transaction authorization platform 230, a cloud computing environment 232, a transaction device 240, and a network 250. Devices of environment 200 may interconnect via wired connections, wireless connections, or a combination of wired and wireless connections.

User device 210 includes one or more devices capable of receiving, generating, storing, processing, and/or providing information associated with authorizing a transaction for a restricted item. For example, user device 210 may include a communication and/or computing device, such as a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device.

Transaction card 220 includes a transaction card that may be used to complete a transaction. For example, transaction card 220 may include a credit card, a debit card, a gift card, a payment card, an automated teller machine (ATM) card, a stored-value card, a fleet card, a transit card, an access card, a virtual card implemented on user device 210, and/or the like. Transaction card 220 may be capable of storing and/or communicating data for a PoS transaction with transaction device 240. For example, transaction card 220 may store and/or communicate data, including account information (e.g., an account identifier, a cardholder identifier, etc.), expiration information of transaction card 220 (e.g., information identifying an expiration month and/or year of transaction card 220), banking information (e.g., a routing number of a bank, a bank identifier, etc.), transaction information (e.g., a payment token), user information (e.g., user data, as described above), and/or the like. For example, to store and/or communicate the data, transaction card 220 may include a magnetic strip and/or an integrated circuit (IC) chip (e.g., a EUROPAY®, MASTERCARD®, or VISA® (EMV) chip).

Transaction card 220 may include an antenna to communicate data associated with transaction card 220. The antenna may be a passive radio frequency (RF) antenna, an active RF antenna, and/or a battery-assisted RF antenna. In some implementations, transaction card 220 may be a smart transaction card, capable of communicating wirelessly (e.g., via Bluetooth, Bluetooth Low Energy (BLE), near-field communication (NFC), and/or the like) with a computing device, such as user device 210, a digital wallet, and/or another device. In some implementations, transaction card 220 may communicate with transaction device 240 to complete a transaction (e.g., based on being moved within communicative proximity of transaction device 240), as described elsewhere herein.

Transaction authorization platform 230 includes one or more devices capable of authorizing and/or facilitating a transaction. For example, transaction authorization platform 230 may include one or more servers and/or computers to store and/or provide information associated with processing a transaction via transaction device 240. In some implementations, transaction authorization platform 230 may process transaction data received from transaction device 240, as described elsewhere herein. Additionally, or alternatively, transaction authorization platform 230 may transmit a notification to user device 210 and/or transaction device 240 and receive a response to the notification from user device 210 and/or transaction device 240, as described elsewhere herein.

Transaction authorization platform 230 may include one or more devices associated with a financial institution (e.g., a bank, a lender, a credit union, and/or the like) and/or a transaction card association that authorizes a transaction and/or facilitates a transfer of funds or payment between an account associated with a cardholder of transaction card 220 and an account of an individual or business associated with transaction device 240. For example, transaction authorization platform 230 may include one or more devices of one or more issuing banks associated with a cardholder of transaction card 220, one or more devices of one or more acquiring banks (or merchant banks) associated with transaction device 240, and/or one or more devices associated with one or more transaction card associations (e.g., VISA®, MASTERCARD®, and/or the like) associated with transaction card 220. Accordingly, based on receiving information associated with transaction card 220 from transaction device 240, devices of transaction authorization platform 230 (e.g., associated with a financial institution or transaction card association) may communicate to authorize a transaction and/or transfer funds between the accounts associated with transaction card 220 and/or transaction device 240.

Transaction authorization platform 230 may provide or deny authorization associated with a transaction. For example, transaction authorization platform 230 may store and/or provide information that may allow, or deny, access through an access point (e.g., a gate, a door, and/or the like) of a secure location (e.g., a room, a building, a geographical area, a transportation terminal, and/or the like) based on information (e.g., account information, a key, an identifier, credentials, and/or the like) associated with transaction card 220 and/or provided by transaction device 240.

Transaction authorization platform 230 may include one or more devices associated with a rewards program associated with transaction card 220 and/or an entity (e.g., a financial institution, a merchant, a service provider, a vendor, and/or the like) associated with transaction card 220 and/or transaction device 240. For example, transaction authorization platform 230 may authorize the earning and/or redemption of rewards (e.g., rewards points associated with transaction card 220, cash rewards, client loyalty rewards associated with an entity associated with transaction device 240, and/or the like) based on a transaction processed by transaction device 240.

Transaction authorization platform 230 may include a server device or a group of server devices. In some implementations, transaction authorization platform 230 may be hosted in cloud computing environment 232. Notably, while implementations described herein describe transaction authorization platform 230 as being hosted in cloud computing environment 232, in some implementations, transaction authorization platform 230 may be non-cloud-based or may be partially cloud-based.

Cloud computing environment 232 includes an environment that delivers computing as a service, whereby shared resources, services, etc. may be provided to user device 210, transaction card 220, transaction device 240, and/or the like. Cloud computing environment 232 may provide computation, software, data access, storage, and/or other services that do not require end-user knowledge of a physical location and configuration of a system and/or a device that delivers the services. As shown, cloud computing environment 232 may include transaction authorization platform 230 and computing resource 234.

Computing resource 234 includes one or more personal computers, workstation computers, server devices, or another type of computation and/or communication device. In some implementations, computing resource 234 may host transaction authorization platform 230. The cloud resources may include compute instances executing in computing resource 234, storage devices provided in computing resource 234, data transfer devices provided by computing resource 234, and/or the like. In some implementations, computing resource 234 may communicate with other computing resources 234 via wired connections, wireless connections, or a combination of wired and wireless connections.

As further shown in FIG. 2, computing resource 234 may include a group of cloud resources, such as one or more applications (“APPs”) 234-1, one or more virtual machines (“VMs”) 234-2, virtualized storage (“VSs”) 234-3, one or more hypervisors (“HYPs”) 234-4, and/or the like.

Application 234-1 includes one or more software applications that may be provided to or accessed by user device 210, transaction card 220, and/or transaction device 240. Application 234-1 may eliminate a need to install and execute the software applications on user device 210, transaction card 220, and/or transaction device 240. For example, application 234-1 may include software associated with transaction authorization platform 230 and/or any other software capable of being provided via cloud computing environment 232. In some implementations, one application 234-1 may send/receive information to/from one or more other applications 234-1, via virtual machine 234-2.

Virtual machine 234-2 includes a software implementation of a machine (e.g., a computer) that executes programs like a physical machine. Virtual machine 234-2 may be either a system virtual machine or a process virtual machine, depending upon use and degree of correspondence to any real machine by virtual machine 234-2. A system virtual machine may provide a complete system platform that supports execution of a complete operating system (“OS”). A process virtual machine may execute a single program and may support a single process. In some implementations, virtual machine 234-2 may execute on behalf of a user (e.g., user device 210 and/or transaction card 220), and may manage infrastructure of cloud computing environment 232, such as data management, synchronization, or long-duration data transfers.

Virtualized storage 234-3 includes one or more storage systems and/or one or more devices that use virtualization techniques within the storage systems or devices of computing resource 234. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 234-4 provides hardware virtualization techniques that allow multiple operating systems (e.g., “guest operating systems”) to execute concurrently on a host computer, such as computing resource 234. Hypervisor 234-4 may present a virtual operating platform to the guest operating systems and may manage the execution of the guest operating systems. Multiple instances of a variety of operating systems may share virtualized hardware resources.

Transaction device 240 includes one or more devices capable of facilitating processing of a transaction associated with transaction card 220. For example, transaction device 240 may include a PoS terminal, a payment terminal (e.g., a credit card terminal, a contactless payment terminal, a mobile credit card reader, a chip reader, etc.), a security access terminal, an automated teller machine (ATM) terminal, and/or the like. In some implementations, transaction device 240 may communicate with transaction authorization platform 230 to provide, to transaction authorization platform 230, information related to a transaction for which transaction card 220 is being used, as described elsewhere herein.

In some implementations, transaction device 240 may include one or more input components and/or output components to facilitate obtaining information from transaction card 220 (e.g., an account number of an account associated with transaction card 220, an expiration date of transaction card 220, etc.), input (e.g., a PIN, a signature, biometric information, etc.), from a cardholder of transaction card 220, related to completing and/or authorizing a transaction, and/or the like. In some implementations, example input components of transaction device 240 may include a number keypad, a touchscreen, a magnetic strip reader, a chip reader, a pen and corresponding signature pad, an RF signal reader, and/or the like.

In some implementations, a magnetic strip reader of transaction device 240 may receive data from transaction card 220 as a magnetic strip of transaction card 220 is swiped along the magnetic strip reader. In some implementations, a chip reader of transaction device 240 may receive data from transaction card 220 via an integrated circuit chip (e.g., an EMV chip) of transaction card 220 when the chip is placed within communicative proximity of the chip reader. In some implementations, an RF signal reader of transaction device 240 may enable a contactless transaction from transaction card 220 and/or user device 210 by obtaining data wirelessly from transaction card 220 and/or user device 210 as transaction card 220 and/or user device 210 comes within communicative proximity of transaction device 240, such that the RF signal reader detects an RF signal from an RF antenna of transaction card 220 and/or user device 210.

In some implementations, example output components of transaction device 240 may include a display, a speaker, a printer, a light, and/or the like. In some implementations, transaction device 240 may use an output component to output information related to a transaction (e.g., an indication to cause a user to input information to authorize a transaction, information that identifies whether a transaction was completed, etc.).

Network 250 includes one or more wired and/or wireless networks. For example, network 250 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

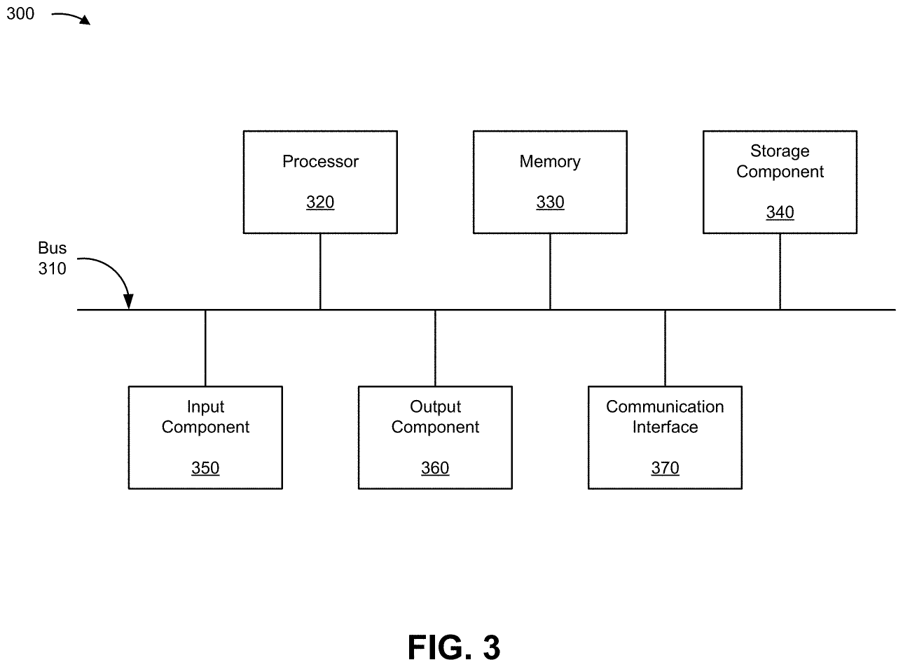

FIG. 3 is a diagram of example components of a device 300. Device 300 may correspond to user device 210, transaction card 220, transaction authorization platform 230, computing resource 234, and/or transaction device 240. In some implementations, user device 210, transaction card 220, transaction authorization platform 230, computing resource 234, and/or transaction device 240 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

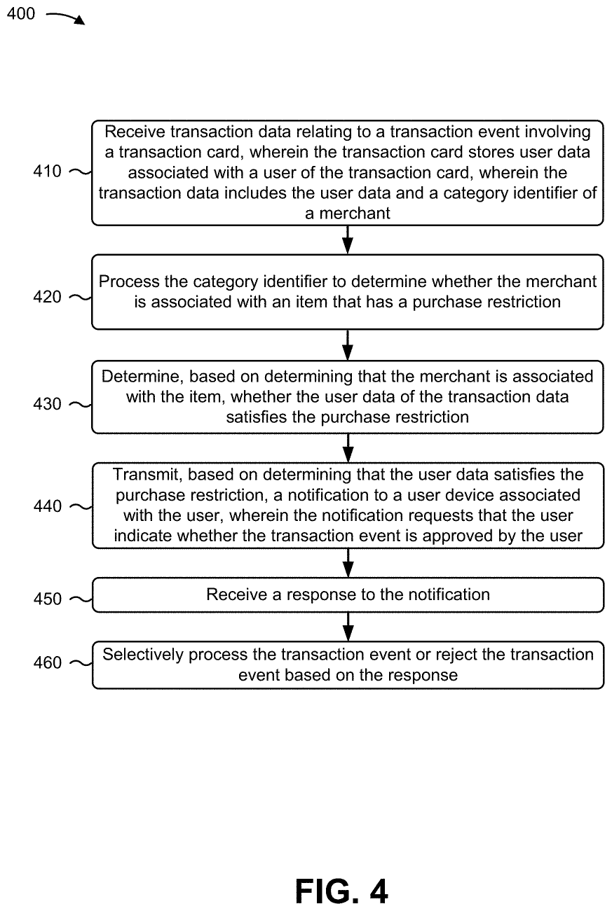

FIG. 4 is a flow chart of an example process 400 for authorizing a transaction for a restricted item based on user data. In some implementations, one or more process blocks of FIG. 4 may be performed by a transaction authorization platform (e.g., transaction authorization platform 230). In some implementations, one or more process blocks of FIG. 4 may be performed by another device or a group of devices separate from or including the transaction authorization platform, such as a user device (e.g., user device 210), a transaction card (e.g., transaction card 220), a computing resource (e.g., computing resource 234), a transaction device (e.g., transaction device 240), and/or the like.

As shown in FIG. 4, process 400 may include receiving transaction data relating to a transaction event involving a transaction card, wherein the transaction card stores user data associated with a user of the transaction card, and wherein the transaction data includes the user data and a category identifier of a merchant (block 410). For example, the transaction authorization platform (e.g., using processor 320, memory 330, storage component 340, input component 350, communication interface 370, and/or the like) may receive transaction data relating to a transaction event involving a transaction card, as described above. In some aspects, the transaction card stores user data associated with a user of the transaction card. In some aspects, the transaction data includes the user data and a category identifier of the merchant.

As further shown in FIG. 4, process 400 may include processing the category identifier to determine whether the merchant is associated with an item that has a purchase restriction (block 420). For example, the transaction authorization platform (e.g., using processor 320, memory 330, storage component 340, and/or the like) may process the category identifier to determine whether the merchant is associated with an item that has a purchase restriction, as described above.

As further shown in FIG. 4, process 400 may include determining, based on determining that the merchant is associated with the item, whether the user data of the transaction data satisfies the purchase restriction (block 430). For example, the transaction authorization platform (e.g., using processor 320, memory 330, storage component 340, and/or the like) may determine, based on determining that the merchant is associated with the item, whether the user data of the transaction data satisfies the purchase restriction, as described above.

As further shown in FIG. 4, process 400 may include transmitting, based on determining that the user data satisfies the purchase restriction, a notification to a user device associated with the user, wherein the notification requests that the user indicate whether the transaction event is approved by the user (block 440). For example, the transaction authorization platform (e.g., using processor 320, memory 330, storage component 340, output component 360, communication interface 370, and/or the like) may transmit, based on determining that the user data satisfies the purchase restriction, a notification to a user device associated with the user, as described above. In some aspects, the notification requests that the user indicate whether the transaction event is approved by the user.

As further shown in FIG. 4, process 400 may include receiving a response to the notification (block 450). For example, the transaction authorization platform (e.g., using processor 320, memory 330, storage component 340, input component 350, communication interface 370, and/or the like) may receive a response to the notification, as described above.

As further shown in FIG. 4, process 400 may include selectively processing the transaction event or rejecting the transaction event based on the response (block 460). For example, the transaction authorization platform (e.g., using processor 320, memory 330, storage component 340, and/or the like) may selectively process the transaction event or reject the transaction event based on the response, as described above.

Process 400 may include additional implementations, such as any single implementation or any combination of implementations described below and/or in connection with one or more other processes described elsewhere herein.

In some implementations, the purchase restriction may relate to one or more of a minimum age, a residence within a jurisdiction, or a status.

In some implementations, selectively processing the transaction event or rejecting the transaction event is to prevent an ineligible user from obtaining the item without approval from the user. In some implementations, the transaction authorization platform may reject the transaction event if the response from the user is not received within a time period after the notification is transmitted.

In some implementations, the transaction data may further include an item identifier and the transaction authorization platform, when processing the category identifier, may process the category identifier and the item identifier of the transaction data to determine whether the merchant is associated with the item that has the purchase restriction.

In some implementations, the transaction authorizing platform may generate a record that associates the transaction event, the purchase restriction, the user data, the response, and information identifying whether the transaction event was processed or rejected and may store the record.

In some implementations, the notification is a first notification and the transaction authorizing platform, when transmitting the first notification, may transmit the first notification to the user device and a second notification to the transaction device, where the second notification indicates that the transaction event is awaiting the response to the first notification.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

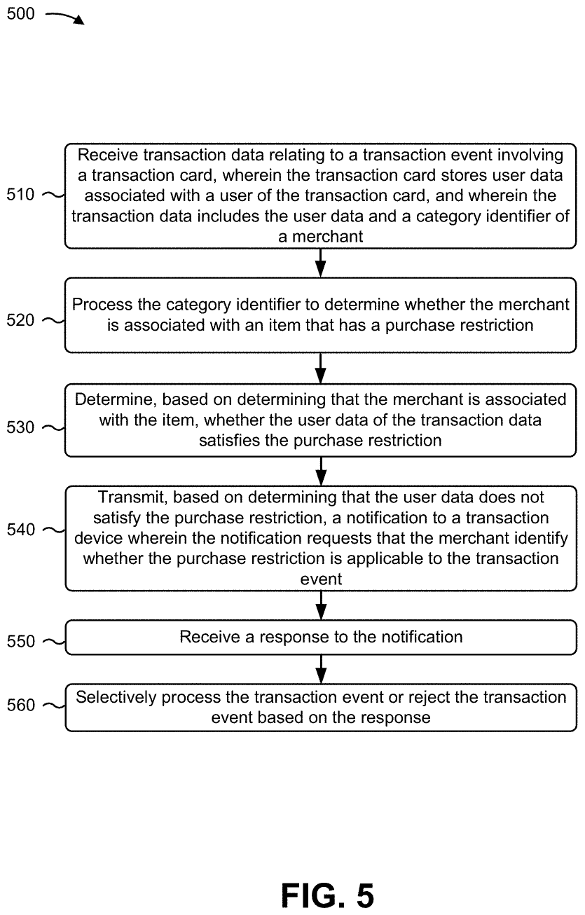

FIG. 5 is a flow chart of an example process 500 for authorizing a transaction for a restricted item based on user data. In some implementations, one or more process blocks of FIG. 5 may be performed by a transaction authorization platform (e.g., transaction authorization platform 230). In some implementations, one or more process blocks of FIG. 5 may be performed by another device or a group of devices separate from or including the transaction authorization platform, such as a user device (e.g., user device 210), a transaction card (e.g., transaction card 220), a computing resource (e.g., computing resource 234), a transaction device (e.g., transaction device 240), and/or the like.

As shown in FIG. 5, process 500 may include receiving transaction data relating to a transaction event involving a transaction card, wherein the transaction card stores user data associated with a user of the transaction card, and wherein the transaction data includes the user data and a category identifier of a merchant (block 510). For example, the transaction authorization platform (e.g., using processor 320, memory 330, storage component 340, input component 350, communication interface 370, and/or the like) may receive transaction data relating to a transaction event involving a transaction card, as described above. In some aspects, the transaction card stores user data associated with a user of the transaction card. In some aspects, the transaction data includes the user data and a category identifier of a merchant.

As further shown in FIG. 5, process 500 may include processing the category identifier to determine whether the merchant is associated with an item that has a purchase restriction (block 520). For example, the transaction authorization platform (e.g., using processor 320, memory 330, storage component 340, and/or the like) may process the category identifier to determine whether the merchant is associated with an item that has a purchase restriction, as described above.

As further shown in FIG. 5, process 500 may include determining, based on determining that the merchant is associated with the item, whether the user data of the transaction data satisfies the purchase restriction (block 530). For example, the transaction authorization platform (e.g., using processor 320, memory 330, storage component 340, and/or the like) may determine, based on determining that the merchant is associated with the item, whether the user data satisfies the purchase restriction, as described above.

As further shown in FIG. 5, process 500 may include transmitting, based on determining that the user data does not satisfy the purchase restriction, a notification to a transaction device wherein the notification requests that the merchant identify whether the purchase restriction is applicable to the transaction event (block 540). For example, the transaction authorization platform (e.g., using processor 320, memory 330, storage component 340, output component 360, communication interface 370, and/or the like) may transmit, based on determining that the user data does not satisfy the purchase restriction, a notification to the transaction device, as described above. In some aspects, the notification requests that the merchant identify whether the purchase restriction is applicable to the transaction event.

As further shown in FIG. 5, process 500 may include receiving a response to the notification (block 550). For example, the transaction authorization platform (e.g., using processor 320, memory 330, storage component 340, input component 350, communication interface 370, and/or the like) may receive a response to the notification, as described above.

As further shown in FIG. 5, process 500 may include selectively processing the transaction event or rejecting the transaction event based on the response (block 560). For example, the transaction authorization platform (e.g., using processor 320, memory 330, storage component 340, and/or the like) may selectively process the transaction event or reject the transaction event based on the response, as described above.

Process 500 may include additional implementations, such as any single implementation or any combination of implementations described below and/or in connection with one or more other processes described elsewhere herein.

In some implementations, the purchase restriction relates to one or more of a minimum age, a residence within a jurisdiction, or a status.

In some implementations, when selectively processing the transaction event or rejecting the transaction event, the transaction authorization platform may reject the transaction event based on the response identifying that the purchase restriction is applicable to the transaction event and may transmit a message to the transaction device indicating that the transaction event is rejected because the user does not satisfy the purchase restriction. In some implementations, the transaction authorization platform may generate a record that associates the transaction event, the purchase restriction, the user data, and information identifying whether the transaction event was processed or rejected and may store the record.

In some implementations, when processing the category identifier, the transaction authorization platform may process the category identifier using a machine-learning model, where the machine-learning model is to output an indication whether the merchant is associated with the item based on the category identifier.

In some implementations, when determining whether the user satisfies the purchase restriction, the transaction authorization platform may determine that the user satisfies the purchase restriction and may process the transaction event without transmitting the notification to the transaction device.

In some implementations, the user data relates to one or more of a date of birth of the user, a residence of the user, or a status of the user.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

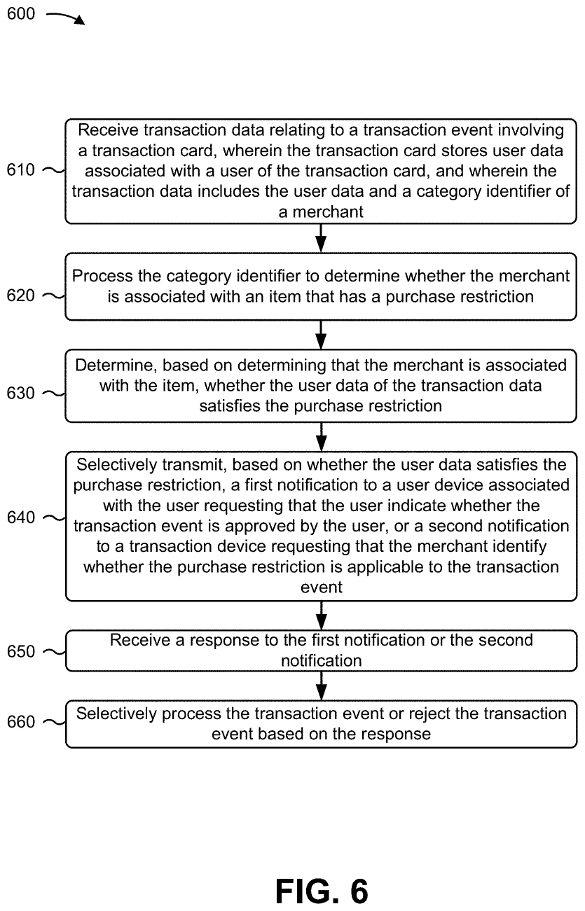

FIG. 6 is a flow chart of an example process 600 for authorizing a transaction for a restricted item based on user data. In some implementations, one or more process blocks of FIG. 6 may be performed by a transaction authorization platform (e.g., transaction authorization platform 230). In some implementations, one or more process blocks of FIG. 6 may be performed by another device or a group of devices separate from or including the transaction authorization platform, such as a user device (e.g., user device 210), a transaction card (e.g., transaction card 220), a computing resource (e.g., computing resource 234), a transaction device (e.g., transaction device 240), and/or the like.

As shown in FIG. 6, process 600 may include receiving transaction data relating to a transaction event involving a transaction card, wherein the transaction card stores user data associated with a user of the transaction card, and wherein the transaction data includes the user data and a category identifier of a merchant (block 610). For example, the transaction authorization platform (e.g., using processor 320, memory 330, storage component 340, input component 350, communication interface 370, and/or the like) may receive transaction data relating to a transaction event involving a transaction card, as described above. In some aspects, the transaction card stores user data associated with a user of the transaction card. In some aspects, the transaction data includes the user data and a category identifier of a merchant.

As further shown in FIG. 6, process 600 may include processing the category identifier to determine whether the merchant is associated with an item that has a purchase restriction (block 620). For example, the transaction authorization platform (e.g., using processor 320, memory 330, storage component 340, and/or the like) may process the category identifier to determine whether the merchant is associated with an item that has a purchase restriction, as described above.

As further shown in FIG. 6, process 600 may include determining, based on determining that the merchant is associated with the item, whether the user data of the transaction data satisfies the purchase restriction (block 630). For example, the transaction authorization platform (e.g., using processor 320, memory 330, storage component 340, and/or the like) may determine, based on determining that the merchant is associated with the item, whether the user data satisfies the purchase restriction, as described above.

As further shown in FIG. 6, process 600 may include selectively transmitting, based on whether the user data satisfies the purchase restriction, a first notification to a user device associated with the user requesting that the user indicate whether the transaction event is approved by the user, or a second notification to a transaction device requesting that the merchant identify whether the purchase restriction is applicable to the transaction event (block 640). For example, the transaction authorization platform (e.g., using processor 320, memory 330, storage component 340, output component 360, communication interface 370, and/or the like) may selectively transmit, based on whether the user data satisfies the purchase restriction, a first notification to a user device associated with the user requesting that the user indicate whether the transaction event is approved by the user, or a second notification to the transaction device requesting that the merchant identify whether the purchase restriction is applicable to the transaction event.

As further shown in FIG. 6, process 600 may include receiving a response to the first notification or the second notification (block 650). For example, the transaction authorization platform (e.g., using processor 320, memory 330, storage component 340, input component 350, communication interface 370, and/or the like) may receive a response to the first notification or the second notification, as described above.

As further shown in FIG. 6, process 600 may include selectively processing the transaction event or rejecting the transaction event based on the response (block 660). For example, the transaction authorization platform (e.g., using processor 320, memory 330, storage component 340, and/or the like) may selectively process the transaction event or reject the transaction event based on the response, as described above.

Process 600 may include additional implementations, such as any single implementation or any combination of implementations described below and/or in connection with one or more other processes described elsewhere herein.

In some implementations, when selectively processing the transaction event or rejecting the transaction event, the transaction authorization platform may reject the transaction event based on the response to the first notification indicating that the transaction event is not approved by the user, and may transmit a message to the transaction device indicating that the transaction event is rejected because the transaction event is not approved by the user. In some implementations, when selectively processing the transaction event or rejecting the transaction event, the transaction authorization platform may reject the transaction event based on the user data of the transaction data not satisfying the purchase restriction and the response to the second notification identifying that the purchase restriction is applicable to the transaction event, and may transmit a message to the transaction device indicating that the transaction event is rejected because the user does not satisfy the purchase restriction.

In some implementations, the transaction data may further include an item identifier, and the transaction authorization platform, when processing the category identifier, may process the category identifier and the item identifier of the transaction data to determine whether the merchant is associated with the item that has the purchase restriction.

In some implementations, the transaction authorization platform, when selectively transmitting the first notification or the second notification, may transmit the first notification based on determining that the user data of the transaction data satisfies the purchase restriction, or transmit the second notification based on determining that the user data of the transaction data does not satisfy the purchase restriction.

In some implementations, the transaction authorization platform may generate a record that associates the transaction event, the purchase restriction, the user data, the response, and information identifying whether the transaction event was processed or rejected, and may store the record.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, and/or a combination of hardware and software.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A method comprising:
receiving, by a device and from a transaction terminal, transaction data relating to a transaction event involving a transaction card,
wherein the transaction terminal is associated with a merchant,
wherein the transaction card electronically stores user data associated with a user of the transaction card,
wherein the user data includes at least one of:
a date of birth of the user,
a residence of the user, or
a status of the user, and
wherein the transaction data includes the user data and a category identifier of the merchant;
processing, by the device and using a machine-learning model, the category identifier to determine whether the merchant is associated with an item that has a purchase restriction,
wherein the machine-learning model is to output an indication of whether the merchant is associated with an item that has a purchase restriction based on the category identifier;
determining, by the device and based on determining that the merchant is associated with the item, whether the user data of the transaction data satisfies one or more parameters associated with the purchase restriction to allow purchasing of the item;
transmitting, by the device and based on determining that the user data does not satisfy the purchase restriction, a first notification to a user device associated with the user,
wherein the first notification requests that the user provide an image, of a form of identification of the user, captured by the user device;
receiving, by the device and from the user device, a first response to the first notification,
the first response including the image;
performing, by the device and based on receiving the first response, image processing on the image to determine whether image data satisfies the purchase restriction;
transmitting, by the device and to the transaction terminal, a second notification requesting that the merchant provide information verifying that the user satisfies the purchase restriction;
receiving, by the device and from the transaction terminal, a second response to the second notification;
selectively processing the transaction event or rejecting the transaction event, by the device, based on determining whether the image data satisfies the purchase restriction and based on the second response to prohibit restricted purchases;
generating, by the device, a record that associates the transaction event, the purchase restriction, the user data, the first response, and information identifying whether the transaction event was processed or rejected; and
storing, by the device, the record.

2. The method of claim 1, wherein the purchase restriction relates to one or more of:
a minimum age,
a residence within a jurisdiction, or
a status.

3. The method of claim 1, wherein selectively processing the transaction event or rejecting the transaction event is to prevent an ineligible user from obtaining the item.

4. The method of claim 1, further comprising:
rejecting the transaction event based on the first response from the user not being received within a time period after the first notification is transmitted.

5. The method of claim 1, wherein the transaction data further includes an item identifier,
wherein processing the category identifier comprises:
processing the category identifier and the item identifier of the transaction data to determine whether the merchant is associated with the item that has the purchase restriction.

6. (canceled)

7. The method of claim 1, further comprising:
transmitting a third notification to the transaction terminal,
wherein the third notification indicates that the transaction event is awaiting the first response to the first notification.

8. A non-transitory computer-readable medium storing instructions, the instructions comprising:
one or more instructions that, when executed by one or more processors, cause the one or more processors to:
receive, from a transaction terminal, transaction data relating to a transaction event involving a transaction card,
wherein the transaction terminal is associated with a merchant,
wherein the transaction card electronically stores user data associated with a user of the transaction card,
wherein the user data includes at least one of:
a date of birth of the user,
a residence of the user, or
a status of the user, and
wherein the transaction data includes the user data and a category identifier of the merchant;
process, using a machine-learning model, the category identifier to determine whether the merchant is associated with an item that has a purchase restriction
wherein the machine-learning model is to output an indication of whether the merchant is associated with an item that has a purchase restriction based on the category identifier;
determine, based on determining that the merchant is associated with the item, whether the user data of the transaction data satisfies one or more parameters associated with the purchase restriction to allow purchasing of the item;
transmit, based on determining that the user data does not satisfy the purchase restriction, a first notification to a user device associated with the user,
wherein the first notification requests that the user provide an image, of a form of identification of the user, captured by the user device;
receive, from the user device, a first response to the first notification,
the first response including the image;
perform, based on receiving the first response, image processing on the image to determine whether image data satisfies the purchase restriction;
transmit, to the transaction terminal, a second notification requesting that the merchant provide information verifying that the user satisfies the purchase restriction;
receive, from the transaction terminal, a second response to the second notification;
selectively process the transaction event or reject the transaction event based on determining whether the image data satisfies the purchase restriction and based on the second response to prohibit restricted purchases;
generate a record that associates the transaction event, the purchase restriction, the user data, the first response, and information identifying whether the transaction event was processed or rejected; and
store the record.

9. The non-transitory computer-readable medium of claim 8, wherein the purchase restriction relates to one or more of:
a minimum age,
a residence within a jurisdiction, or
a status.

10. The non-transitory computer-readable medium of claim 8, wherein the one or more instructions, that cause the one or more processors to selectively process the transaction event or reject the transaction event, cause the one or more processors to:
reject the transaction event based on the image data not satisfying the purchase restriction; and
wherein the one or more instructions, when executed by the one or more processors, further cause the one or more processors to:
transmit, based on rejecting the transaction event, a message to the transaction terminal indicating that the transaction event is rejected.

11. (canceled)

12. (canceled)

13. (canceled)

14. (canceled)

15. A device, comprising:
one or more memories; and
one or more processors communicatively coupled to the one or more memories, configured to:
receive, from a transaction terminal, transaction data relating to a transaction event involving a transaction card,
wherein the transaction terminal is associated with a merchant,
wherein the transaction card electronically stores user data associated with a user of the transaction card,
wherein the user data includes at least one of:
a date of birth of the user,
a residence of the user, or
a status of the user, and
wherein the transaction data includes the user data and a category identifier of the merchant;
process, using a machine-learning model, the category identifier to determine whether the merchant is associated with an item that has a purchase restriction,
wherein the machine-learning model is to output an indication of whether the merchant is associated with an item that has a purchase restriction based on the category identifier;
determine, based on determining that the merchant is associated with the item, whether the user data of the transaction data satisfies one or more parameters associated with the purchase restriction to allow purchasing of the item;
selectively transmit, based on whether the user data satisfies the purchase restriction, a first notification to a user device associated with the user requesting that the user provide an image, of a form of identification of the user, captured by the user device;
receive, from the user device, a first response to the first notification,
the first response including the image;
perform, based on receiving the first response, image processing on the image to determine whether image data satisfies the purchase restriction;
transmit, to the transaction terminal, a second notification requesting that the merchant provide information verifying that the user satisfies the purchase restriction;
receive, from the transaction terminal, a second response to the second notification;
selectively process the transaction event or reject the transaction event based on determining whether the image data satisfies the purchase restriction and based on the second response to prohibit restricted purchases;
generate a record that associates the transaction event, the purchase restriction, the user data, the first response, and information identifying whether the transaction event was processed or rejected; and
store the record.

16. The device of claim 15, wherein the one or more processors, when selectively processing the transaction event or rejecting the transaction event, are to:
reject the transaction event based on the second response including information that does not satisfy the purchase restriction; and
where the one or more processors are further to:
transmit, based on rejecting the transaction event, a message to the transaction terminal indicating that the transaction event is rejected.

17. The device of claim 15, wherein the one or more processors, when selectively processing the transaction event or rejecting the transaction event, are to:
reject the transaction event based on the image data not satisfying the purchase restriction or the second response including information that does not satisfy the purchase restriction; and
where the one or more processors are further to:
transmit, based on rejecting the transaction event, a message to the transaction terminal indicating that the transaction event is rejected.

18. The device of claim 15, wherein the transaction data further includes an item identifier,
wherein the one or more processors, when processing the category identifier, are to:
process the category identifier and the item identifier of the transaction data to determine whether the merchant is associated with the item that has the purchase restriction.

19. The device of claim 15, wherein the one or more processors, when selectively transmitting the first notification, are to:
transmit the first notification based on determining that the user data of the transaction data does not satisfy the purchase restriction.

20. (canceled)

21. The non-transitory computer-readable medium of claim 8, wherein the first notification includes a request for the user to provide the form of identification to the merchant and receive, from the merchant, a verification code.

22. The method of claim 1, wherein the user data further includes information indicating whether the user has been convicted of a felony.

23. The non-transitory computer-readable medium of claim 8, wherein the user data further includes information indicating whether the user has been convicted of a felony.

24. The non-transitory computer-readable medium of claim 8, wherein the one or more instructions, when executed by the one or more processors, further cause the one or more processors to:
utilize a mapping that associates one or more category identifiers to one or more purchase restrictions; and
wherein the one or more instructions, that cause the one or more processors to determine whether the user data of the transaction data satisfies the one or more parameters associated with the purchase restriction to allow purchasing of the item, cause the one or more processors to:
determine whether the user data of the transaction data satisfies the one or more parameters associated with the purchase restriction based on utilizing the mapping that associates the one or more category identifiers to the one or more purchase restrictions.

25. The non-transitory computer-readable medium of claim 24, wherein the mapping comprises one or more of:
a mapping that associates a category identifier for grocery stores with a purchase restriction relating to alcoholic beverages,
a mapping that associates a category identifier for liquor stores with a purchase restriction relating to alcoholic beverages,
a mapping that associates a category identifier for sporting goods stores with a purchase restriction relating to firearms,
a mapping that associates a category identifier for movie theaters with a purchase restriction relating to R-rated movies,
a mapping that associates an item identifier for alcoholic beverages to a purchase restriction relating to alcoholic beverages,
a mapping that associates an item identifier for fireworks to a purchase restriction relating to fireworks, or
a mapping that associates an item identifier for firearms to a purchase restriction relating to firearms.

26. The device of claim 15, wherein the user data further includes information indicating whether the user has been convicted of a felony.
